(19) United States
(12) Patent Application Publication
(10) Pub. No.: US 2025/0259295 A1
(43) Pub. Date: Aug. 14, 2025

(54) MACHINE VISION CHANGE DETECTION FOR PROCESS MONITORING

(71) Applicant: Ford Global Technologies, LLC, Dearborn, MI (US)

(72) Inventors: John Erik Mikael Hellstrom, Ann Arbor, MI (US); Khalid Nayaz Ahmed, Canton, MI (US); Bogdan Bude, Canton, MI (US)

(73) Assignee: Ford Global Technologies, LLC, Dearborn, MI (US)

(21) Appl. No.: 18/440,503

(22) Filed: Feb. 13, 2024

(51) Int. Cl. G06T 7/00; G06V 10/24; G06V 10/25; G06V 10/26; G06V 10/762; G06V 10/764; G06V 20/52

(52) U.S. Cl. CPC G06T 7/001; G06V 10/24; G06V 10/25; G06V 10/273; G06V 10/762; G06V 10/764; G06V 20/52; G06T 2207/20076; G06T 2207/20081; G06T 2207/20084; G06T 2207/30108

(57) ABSTRACT

A method for a metric determination includes extracting one or more features from a plurality of images and classifying the plurality of images based on the extracted one or more features to form one or more clusters of images, wherein the classifying is performed at least in part based on machine learning. Hypothesis testing is performed on the one or more clusters of images based on one or more production factors and variations are identified in the one or more features resulting from the hypothesis testing. One or more production metrics are determined based on the identified variations.

### FIELD

The present disclosure relates to monitoring of production processes. More specifically, the present disclosure relates to systems and methods directed toward monitoring production processes to detect changes in the production processes based on acquired images of the processes.

### BACKGROUND

The statements in this section merely provide background information related to the present disclosure and may not constitute prior art.

Manufacturing processes may be supervised with vision-based systems to monitor the processes. The interpretation of acquired images can be challenging. Some monitoring systems use artificial intelligence and machine learning (AI/ML) techniques coupled with image data sets to facilitate identifying features of interest in monitored processes. However, generating sufficient data with desired properties for algorithm training can be difficult. It is also often time consuming to introduce anomalies into a process for training, as well as difficult to know how anomalies will appear prior to actual production issues.

The present disclosure addresses these and other issues related to monitoring production processes to detect changes in the production process based on acquired images of the processes.

### SUMMARY

This section provides a general summary of the disclosure and is not a comprehensive disclosure of its full scope or all of its features.

The present disclosure provides a computerized method comprising: extracting one or more features from a plurality of images; classifying the plurality of images based on the extracted one or more features to form one or more clusters of images, the classifying performed at least in part based on machine learning; performing hypothesis testing on the one or more clusters of images based on one or more production factors; identifying variations in the one or more features resulting from the hypothesis testing; and determining one or more metrics (e.g., production metrics) based on the identified variations; wherein the plurality of images comprises current images of a product along a production line and past images of a similar product along the production line; wherein each image of the plurality of images is classified into one of two clusters and the hypothesis testing uses a null hypothesis to identify variations in the images of the two clusters; further comprising rejecting the null hypothesis in response to an observed probability being greater than a threshold for a defined significance level; wherein the plurality of images comprises images of a product along an assembly line and further comprising monitoring one or more production processes for the product using the one or more metrics; wherein the one or more production factors comprise one or more of inputs, noise, process changes, or a combination thereof; wherein the process changes comprise a change to at least one of a date and time of production, an operator, a tool, a production, or a combination thereof; wherein the product comprises a vehicle high-voltage battery pack and the one or more features relate to cell tab welds for cells within the vehicle high-voltage battery pack; and further comprising preprocessing the plurality of images, wherein the preprocessing comprises centering and cropping each image of the plurality of images on a region of interest and masking out other regions of each of the images corresponding to noise.

The present disclosure provides a system comprising: a plurality of cameras configured to acquire a plurality of images of products along a production line; and a monitoring system receiving the plurality of images and configured to: extract one or more features from the plurality of images; classify the plurality of images based on the extracted one or more features to form one or more clusters of images, the classifying performed at least in part based on machine learning; perform hypothesis testing on the one or more clusters of images based on one or more production factors; identify variations in the one or more features resulting from the hypothesis testing; and determine one or more metrics based on the identified variations to thereby monitor the products; wherein the plurality of images comprises current images of the products along the production line and past images of a similar product along the production line; wherein each image of the plurality of images is classified into one of two clusters and the hypothesis testing uses a null hypothesis to identify variations in the images of the two clusters; wherein the monitoring system is further configured to reject the null hypothesis in response to an observed probability being greater than a threshold for a defined significance level; wherein the one or more production factors comprises one or more of inputs, noise, process changes, or a combination thereof; wherein the process changes comprise a change to at least one of a date and time of production, an operator, a tool, a production, or a combination thereof; wherein the products comprise a vehicle high-voltage battery pack and the one or more features relate to cell tab welds for cells within the vehicle high-voltage battery pack; wherein the monitoring system is further configured to preprocess the plurality of images, wherein the preprocessing comprises centering and cropping each image of the plurality of images on a region of interest and masking out other regions of each of the images corresponding to noise.

The present disclosure provides one or more non-transitory computer-readable media storing processor-executable instructions that, when executed by at least one processor, cause the at least one processor to: extract one or more features from a plurality of images; classify the plurality of images based on the extracted one or more features to form one or more clusters of images, the classifying performed at least in part based on machine learning; perform hypothesis testing on the one or more clusters of images based on one or more production factors; identify variations in the one or more features resulting from the hypothesis testing; and determine one or more metrics based on the identified variations; wherein each image of the plurality of images is classified into one of two clusters and the hypothesis testing uses a null hypothesis to identify variations in the image of the two clusters, and wherein the at least one processor is further caused to: reject the null hypothesis in response to an observed probability being greater than a threshold for a defined significance level; wherein the products comprise a vehicle high-voltage battery pack and the one or more features relate to cell tab welds for cells within the vehicle high-voltage battery pack, and wherein the at least one processor is further caused to: preprocess the plurality of images, wherein the preprocessing comprises centering and cropping each image of the plurality of images on a region of interest and masking out other regions of each of the images corresponding to noise.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an overall system for monitoring a production process in accordance with various implementations;

FIG. 2 is a perspective view of an example of a battery cell that can be produced by the production process of FIG. 1;

FIG. 3 is a front view, in cross-section, of the battery cell of FIG. 2;

FIG. 4 is a block diagram of the inspection station in FIG. 1;

FIG. 5 is a flow diagram illustrating a machine learning pipeline in accordance with an implementation; and

FIG. 6 is a flowchart illustrating an example method for a metric determination in accordance with various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a means for monitoring of a production process for variations or changes based on images and known production factors without the use of any data with known labels for the images represent. For example, various implementations provide monitoring of production processes where images provide useful information on the process variability. In some implementations, machine vision variation (e.g., change) detection is performed on one or more production or manufacturing processes, such as analyzing variability in high-voltage battery pack production using machine vision classification with respect to images of cell tab welds of the battery packs. It should be appreciated that the monitoring and vision classification of various implementations is not limited to applications with battery pack production, but can be used in any type of production or manufacturing process.

Machine vision classification methods may be broadly categorized as supervised or unsupervised, where the former uses information on the production status of images (labels). One or more herein described methods perform machine vision classification without labels (e.g., without using image labels), thereby eliminating the challenging and complex process of obtaining accurate labels.

Various implementations of detection methods disclosed herein are unsupervised with the salient feature, relative to existing unsupervised methods. That is, the unsupervised methods detect variations or changes in a process. While existing unsupervised methods may cluster data, there is no interpretation on the meaning (e.g., label) of the cluster. One or more examples use an interpretation by means of hypothesis testing to assess whether there are variations (e.g., significant variations) in the image features based on one or more known production factors (e.g., date and time of production, operator, tool, production line, etc.). Moreover, the nature of image capturing and reduced computational requirements for one or more algorithms described herein allows for more efficient monitoring of large production volumes, and also, may therefore complement slower procedures where individual samples are taken off the production line for inspection and testing. Thus, various examples combine null hypothesis from probability theory with image clustering from machine learning, to determine if any change in the manufacturing process caused changes to the product being manufactured.

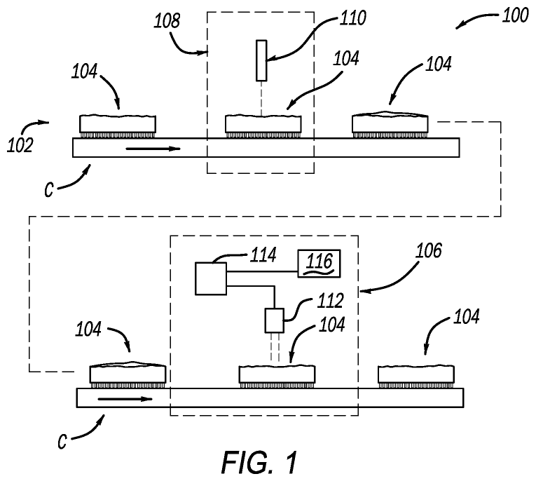

FIG. 1 shows a schematic block diagram illustration of a process monitoring system 100, such as for inspection of a production (e.g., manufacturing or assembly) line 102. In one example, the process monitoring system 100 is configured to identify variations in the one or more features of products 104 being produced (e.g., manufactured or assembled) along the production line 102. As described in more detail herein, the variations are identified as a result of hypothesis testing and one or more metrics are determined based on the identified variations. In one example, the product 104 is a vehicle high-voltage battery pack and the one or more features relate to cell tab welds for cells within the vehicle high-voltage battery pack. That is, the production line 102 is a battery manufacturing production line that includes at least the welding of cell tabs for vehicle high-voltage battery packs. However, the herein described implementations can be used for monitoring to detect variations in other types of products and/or based on other types of monitoring applications.

In the illustrated example, the process monitoring system 100 includes a feature inspection station 106 that identifies variations in the one or more features, such as weld features for vehicle high-voltage battery packs. As such, the feature inspection station 106 in some examples is a weld inspection station.

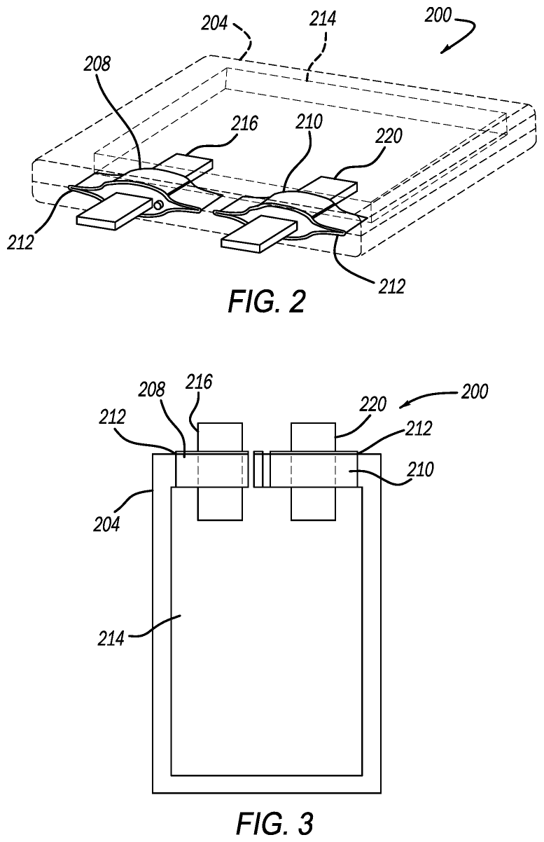

Continuing with the battery pack production example, the production line 102 includes a conveyor ‘C’ configured to transport products 104, in this case batteries, into and out of an operation station, illustrated as a welding station 108, although the batteries can be transported into and out of the welding station 108 using other types of transport mechanisms or devices, including manual and/or robotic transport of the products 104. The welding station 108 includes a welder 110 (e.g., a laser welder) configured to perform cell tab welding on the battery packs. For example, the cell tab welding can be performed on a battery cell assembly 200 as shown in FIGS. 2 and 3. The battery cell assembly 200 may be structured as a pouch battery cell assembly or other battery cell assembly. More than one battery cell assembly 200 may be aligned in an array with busbars interconnecting the battery cell assemblies 200 in parallel or series to provide power for vehicle components. For example, a plurality of battery cell assemblies 200 may be in electrical communication with one another within a traction battery.

The battery cell assembly 200 in the illustrated example includes a housing 204, a first intermediate terminal member 208, and a second intermediate terminal member 210. The first intermediate terminal member 208 and the second intermediate terminal member 210 can have may suitable shape extend from opposing ends. A seal 212 may be located between the housing 204 and the first intermediate terminal member 208, and between the housing 204 and the second intermediate terminal member 210. Additionally, an upper portion of the housing 204 and a lower portion of the housing 204 may be sealed to one another. The housing 204 may define a cavity 214 sized to retain battery cell active materials such as an anode, a cathode, a separator, and electrolyte. The housing 204 for pouch battery cells may be made of a conformal polymer/aluminum laminate vacuum sealed about the battery cell active materials. For example, two separate stacked laminate pieces may be sealed on all four edges or one single laminate piece folded in half may be sealed along either three or all four edges.

A first terminal tab 216 may be embedded within the first intermediate terminal member 208 and a second terminal tab 220 may be embedded within the second intermediate terminal member 210. Each of the terminal tabs may be embedded with the respective intermediate terminal member via, for example, injection molding, 3D printing, or casting. In some examples, the welder 110 forms weld tabs and/or electrically connects the first and second terminal tabs 216, 220 to a control board or other components of the battery cell assembly 200 with the welding operation.

In some examples, after performing the welding operation (e.g., forming the cell tab welds), the conveyor C transports each of the batteries to the inspection station 106 (in this example a weld inspection station) where the plurality of welds is automatically inspected using an (i) imaging device, such as a camera 112 and (ii) a control system 114 as described in more detail herein. Non-limiting examples of the camera 112 include two-dimensional (2D) cameras such as a 2D area camera, a 2D line scan camera, among others, and three-dimensional (3D) cameras such as a 3D laser scanner, a 3D area camera, among others. In some variations the results of the automated inspection are displayed on a display screen 116. And after leaving the inspection station 106, an inspected battery is removed from the inspection station 106, which may be further processed.

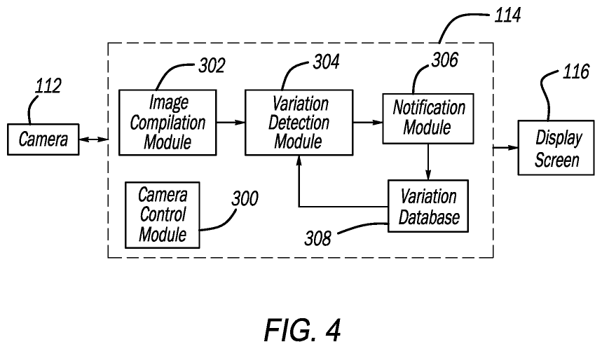

Referring to FIG. 4, the camera 112, the control system 114, and the display screen 116 are shown. The control system 114 includes a camera control module 300 configured to command the camera 112 to acquire one or more images of features (e.g., the plurality of welds) for each of the products 104, namely the welded batteries in this example, entering the inspection station 106. In some implementations, the camera control module 300 is configured to command or set a camera angle, a focus, and a zoom for the camera 112. In at least one example, the camera control module 300 is configured to command the camera 112 to acquire a series of images of the welds as each battery moves past and within a field of view (e.g., scanning area) of the camera 112, such that the camera 112 scans and acquires the images of the plurality of welds as the battery moves relative to the camera 112. In examples where the camera 112 is a 2D line scan camera or a 3D laser scanner, an image compilation module 302 compiles the series of images into one or more compiled images that are analyzed by a variation detection module 304.

The variation detection module 304 is configured to detect or identify changes or variations in one or more features of the products 104 using hypothesis testing as described in more detail herein. The detected changes or variations allow for determining one or more metrics for the production line 102. In one example, the detected variations related to cell tab welds for cells within a battery pack allow for determining a characteristic of the seal for the battery pack (e.g., ensure that the electrolyte pack for the battery is sealed, such as ensuring that the pouch of the battery cell assembly 200 is completely sealed). In some examples, the variation detection module 304 allows for detection of anomalies in the welds, for example, the cell tab welds for the battery packs that may be caused by a change in the production process, a change in the welding nozzle, etc. Thus, the variation detection module 304 allows for identifying characteristics (e.g., visual characteristics) of the one or more features (e.g., cell tab welds) and any variations to determine one or more metrics. It should be appreciated that the one or more features and the one or more metrics can be related to any production process and are not limited to the production of battery packs.

In some implementations, the variation detection module 304 identifies variations that then allow for providing, as the metric, a score (e.g., a number from 1 to 10 that is an anomaly score) for identified production issues, such as anomalies on the surface of the welds based on the severity or amount of each anomaly on the surface. Some examples of the severity or amount of the anomalies include a percentage of surface area having anomaly discoloration (e.g., determined via a pixel color comparison), size of a weld relative to a predefined size or predefined size range, number of pits, size of a pit, number of cracks, size of a crack, number of stringers or valleys, and size of a stringer or valley, among others. In some examples, the variation detection module 304 identifies variations in the one or more features (e.g., cell tab welds) that allows for determining or tabulating an overall score for each feature (e.g., weld) based on the score of each identified anomaly. In one or more examples, the determined metrics, such as a score, is transmitted to a notification module 306. In some implementations, the notification module 306 provide a visual, audible, or tactile notification based on the identified variations.

In some implementations, the variation detection module 304 is trained (or uses an algorithm that is trained) to identify the variations (e.g., anomalies). And in at least one implementation, the variation detection module 304 is continuously trained to identify the variations. In one or more implementations, the variation detection module 304 includes or receives data trained by a neural network with a plurality of input units, hidden units, and output units. And in at least one implementation, the neural network is a feedforward network trained via backpropagation. In some implementations, as described in more detail herein, training of an algorithm allows for feature extraction without image labels that are then used for hypothesis testing to assess whether there are significant variations in image features based on the known production factors. Accordingly, in some examples, the variation detection module 304 is trained to distinguish between variations, such as variations that affect the production process and variations that do not affect the production process (e.g., discoloration present on a surface of “pass” welds from contamination discoloration present on a surface of “no-pass” welds). As described in more detail herein, one or more examples thereby enable reasoning about image variations and not weld strength.

In some examples, the notification module 306 is configured to generate a report, such as based on an overall score determined by the variation detection module 304. In some implementations, the report and/or some version of the report is transmitted and displayed on the display screen 116 such that it can be viewed by an operator. Non-limiting examples of information included in report and/or some version of the report displayed on the display screen 116 for the welding example include number of “pass” welds, number of “no-pass” welds, number of “need further inspection” welds, type(s) of anomalies detected or identified, location of anomalies, an image of identified anomalies, a partial image of the welds, an image of all the welds, and an image of a welded battery showing one or more locations where one or more anomalies have been identified, among others.

In some variations the notification module 306 provides a list of identified variations, such as identified anomalies, to a variation database 308, such that the variation database 308 is updated. In addition, in at least one example, the updated variation database 308 is used to further train the variation detection module 304.

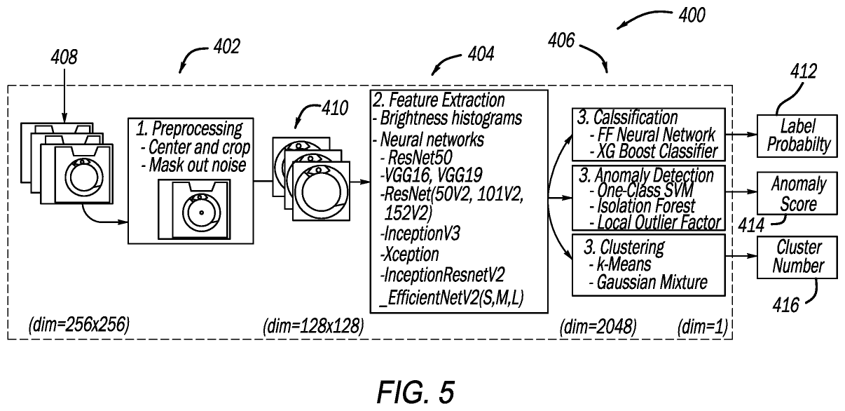

FIG. 5 is a flow diagram illustrating a machine learning pipeline 400 that can be used to detect variations, such as with the variation detection module 304 in various examples. As described herein, in some examples, cell tab weld analysis is performed using the machine learning pipeline 400, which is configured as an AI/ML machine vision pipeline that allows for weld image analysis. The machine learning pipeline 400 in the illustrated example includes preprocessing at 402, feature extraction at 404, and classification/anomaly detection at 406. It should be appreciated that the machine learning pipeline 400 can be performed in multiple steps that can each be performed one or more times. The machine learning pipeline 400 identifies variations in image features (X), where X=G(I,Z) and the weld strength (Y) is defined as Y=F(X) in some examples as described in more detail below.

The machine learning pipeline 400 in one implementation is configured to receive as an input, production images 408 (e.g., raw production images or SDI images) and production factor pairs as described in more detail herein. The machine learning pipeline 400 is configured to preprocess the input and generate one or more outputs that may be used to generate a notification, such as with the notification module 306, and/or display the results on the display screen 116 (e.g., a change is or is not detected). In one example, the input data is SDI data that includes the images (I), which are a pixel matrix, and production factor pairs that include production factors Z (e.g., date, tab, line side, etc.) and SDI labels (i.e., I,Z→(Y<threshold)), which defines two populations as described in more detail herein.

With respect to the preprocessing at 402, one or more different types of image preprocessing is performed, such as centering and cropping the raw images (e.g., centering and cropping the images on the pertinent part of the image, such as the weld), as well as masking out noise (e.g., mask out any other irrelevant parts (noise) in the images). It should be appreciated that any type of image preprocessing techniques may be used, such as to reduce the signal to noise ratio. One or more processed images 410 are output for feature extraction at 404.

The machine learning pipeline 400 then perform feature extraction (G) at 404. For example, image features may be extracted by applying processing operations (e.g., neural network processing) that have been trained for other tasks. In one example, a classifier and the corresponding neural network feature extraction architecture is trained on publicly available large databases of natural images and labels. In one implementation, after training, only the feature extraction part is retained and used to extract features from images to feed into the next clustering step. It should be appreciated that any type of neural network may be used to perform the feature extraction at 404. Additionally, different processing may be performed, such as using brightness histograms or other data.

Classification/anomaly detection is then performed on the extracted features at 406, which includes hypothesis testing in some examples as described in more detail herein. For example, the key output variables for the process are denoted by the vector Y and the key input variables by the vector X. The assumption for vision-based monitoring in various examples is that X is a function of the images (e.g., the preprocessed images 410), denoted by I (a matrix of pixels). In addition, the classification and anomaly detection is performed so that the output is consistent across production factors, denoted by the vector Z. The factors in some examples are derived from date and time of production, operator, tool, production line, etc. The model of the process in one implementation is defined as: Y=F(X)=F(G(I, Z)), where the process is configured to reason about G: I, Z→X without having information on the output Y. Specifically, the process operates to infer if there are significant differences between two image populations with different factors Z and thereby concludes (e.g., outputs) if the process is stable across these image populations.

In one example, P₁ and P₂ denote two populations of images, each with n images, with at least one factor in the associated vectors Z₁ and Z₂ is different. The null hypothesis is defined as follows, H₀: There is no difference between the two image populations P₁ and P₂. Next, clustering is applied to the two sets of features {X=G(i, Z), i∈P}, k=1,2 and a determination is made if the populations can be separated with an accuracy significantly different from random.

The clustering operation is configured to group the images (e.g., the preprocessed images 410), as represented by the image features, into two clusters. This is performed in one example by selecting a similarity measure between images and an algorithm to find cluster assignments, such that the similarities among images in each cluster are smaller than in the other cluster. Any suitable techniques can be used, such as using a Euclidian distance with K-means and Gaussian mixture model with expectations maximization. However, other suitable techniques may be used.

The clustering operation assigns each image to one of the two clusters, which can be represented by two sets denoted by C₁ and C₂ containing the images assigned to the respective set. Next, the number of correct assignments, denoted by m, is computed under the situations that each image set is fully isolated in either set, as follows: m=max{|P∩C|+|P∩C|,|P∩C|+|P∩C|}, where |P∩C| is the number of images in population P in cluster C₁,k=1,2,l=1,2. The maximum operation is used in various examples because the numbering of the clusters from a clustering algorithm is arbitrary. That is, by definition, n≤m≤2n.

Under the null hypothesis, there is no difference between the two image populations and the number of correct assignments m is random. Specifically, m follows a binomial distribution and the stochastic variable M∈Bin(2n, p) with probability p=0.5 (ratio of correct answers). The null hypothesis is thus restated as: H₀:p=0.5. In various examples, the null hypothesis is rejected if the observed probability (accuracy) m/2n is larger than the threshold for a significance level a (populations are different). On the other hand, if the observed probability is not larger than the threshold, the null hypothesis is not rejected (difference between populations cannot be established). For example, for 2n=200 images and a significance level of α=0.001 gives m/2n>61.5%⇒reject H₀, otherwise do not reject H₀.

The classification and anomaly detection at 406, which includes clustering in some examples as described herein, generates one or more outputs. For example, the classification at 406 generates as an output a label probability 412 (e.g., a probability of the correct label based on the classification), the anomaly detection generates as an output an anomaly score 414, and the clustering generates as an output a cluster number 416. It should be noted that the classification, anomaly detection, and clustering can be performed using different processes, and the implementations described herein are provided as examples.

Thus, with the feature extraction developed, one or more anomalies are identified and image variations analyzed with unsupervised machine learning as described herein. It should be appreciated that the feature extraction in some examples is validated using SDI labels with supervised methods.

In operation, with one or more of the herein described processes being implemented, for example the machine learning pipeline 400, one or more examples may be applied to monitoring production processes, such as with the monitoring system 100, to detect changes in selected population pairs based on the production factors (e.g., inputs, noise, and processes). Returning to the example application of cell tab welding for high-voltage battery packs, one implementation will now be described.

In this case of cell tab welding, the factors of interest in one example are production period and two production line related factors (with levels 1 or 2 for one factor and levels A or B for the other factor). A monitoring process according to one or more examples is then configured as follows:

1. Period-to-period changes for a given line may be detected by selecting the following four population pairs: Population 1 from current period and each of the four unique combinations of the two production line factors. Population 2 from the last period with the same production line factor combination as for population 1.

2. Production line-to-line changes for the current period may be detected by selecting the following four pairs: Population 1 from current period and each of the for unique combinations of the two production line factors. Population 2 from the current period with one of the production line factors changed.

The process monitoring can be extended to additional factors. In this example, it should be noted that for the line-to-line changes, there are in total

$$( \begin{matrix}line factor levels \\ 2\end{matrix} ) = ( \begin{matrix}4 \\ 2\end{matrix} ) = 6 pairs , \qquad ( 4 )$$

which include the pairs where, for the same period, both line factors are different. In general, such factor combinations may be included, but it should be noted that the combinations are not relevant in this application.

Next, the population sample size n is selected to be limited to the minimum of the available samples in the pairs. Next, the process randomly samples n samples from the larger population and repeats this process multiple times (e.g., depending on the population size differences). Finally, the hypothesis test is evaluated by assessing the statistics of the observed accuracy [symbol] n against the threshold (computed from Bin(2n, 0.5)) based on the selected significance level. With this implementation, process variations can thereby be identified.

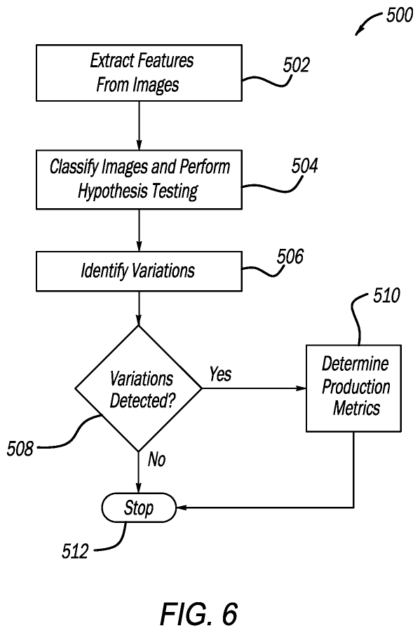

FIG. 6 is a flowchart illustrating an example method 500 for a metric determination, such as production metrics related to cell tab welds for cells within a battery pack. At operation 502, one or more features are extracted from a plurality of images. As described in more detail herein, the features are extracted from preprocessed images (e.g., raw images that are centered and cropped on a region of interest and other regions masked out) in some examples and related to a welding operation. The images in some examples are current images of a product (e.g., battery pack) along a production line and past images of a similar product along the production line.

At operation 504, the images are classified based on the extracted features to form one or more clusters of images. In some examples, as described herein, the classifying is performed at least in part based on machine learning. Hypothesis testing is also performed on the one or more clusters of images based on one or more production factors (e.g., one or more of inputs, noise, and process changes (such as at least one of a date and time of production, an operator, a tool, a production, or a combination thereof)). For example, the images are classified into one of two clusters and the hypothesis testing uses a null hypothesis to identify variations in the images of the two clusters. In one example, in response to an observed probability being greater than a threshold for a defined significance level as described herein, the null set hypothesis is rejected. In response to an observed probability being lesser than the threshold for the defined significance level as described herein, the null set hypothesis is accepted.

At operation 506, variations in the one or more features are identified. For example, the variations are identified resulting from the hypothesis testing. In one example, where the images comprise images of a product along an assembly line, one or more production processes are monitored for the product to determine production metrics at 510. That is, in response to a determination that variations are detected (e.g., weld anomalies) in the one or more of the production processes at 508, one or more production metrics are determined at 510 based on the identified variations and a corresponding alert can be generated as described in more detail herein. In response to no variations being detected, the method 800 stops at 512.

Thus, one or more implementations provide for monitoring of a production process for changes based on images and known production factors without using any data with known labels relating to a characteristic that the images represent.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A computerized method comprising:
extracting one or more features from a plurality of images;
classifying the plurality of images based on the extracted one or more features to form one or more clusters of images, the classifying performed at least in part based on machine learning;
performing hypothesis testing on the one or more clusters of images based on one or more production factors;
identifying variations in the one or more features resulting from the hypothesis testing; and
determining one or more production metrics based on the identified variations.

2. The computerized method of claim 1, wherein the plurality of images comprises current images of a product along a production line and past images of a similar product along the production line.

3. The computerized method of claim 1, wherein each image of the plurality of images is classified into one of two clusters and the hypothesis testing uses a null hypothesis to identify variations in the images of the two clusters.

4. The computerized method of claim 3, further comprising rejecting the null hypothesis in response to an observed probability being greater than a threshold for a defined significance level.

5. The computerized method of claim 1, wherein the plurality of images comprises images of a product along an assembly line and further comprising monitoring one or more production processes for the product using the one or more production metrics.

6. The computerized method of claim 5, wherein the one or more production factors comprise one or more of inputs, noise, process changes, or a combination thereof.

7. The computerized method of claim 6, wherein the process changes comprise a change to at least one of a date and time of production, an operator, a tool, a production, or a combination thereof.

8. The computerized method of claim 5, wherein the product comprises a vehicle high-voltage battery pack and the one or more features relate to cell tab welds for cells within the vehicle high-voltage battery pack.

9. The computerized method of claim 1, further comprising preprocessing the plurality of images, wherein the preprocessing comprises centering and cropping each image of the plurality of images on a region of interest and masking out other regions of each of the images corresponding to noise.

10. A system comprising:
a plurality of cameras configured to acquire a plurality of images of products along a production line; and
a monitoring system receiving the plurality of images and configured to:
extract one or more features from the plurality of images;
classify the plurality of images based on the extracted one or more features to form one or more clusters of images, the classifying performed at least in part based on machine learning;
perform hypothesis testing on the one or more clusters of images based on one or more production factors;
identify variations in the one or more features resulting from the hypothesis testing; and
determine one or more production metrics based on the identified variations to thereby monitor a production of the products.

11. The system of claim 10, wherein the plurality of images comprises current images of the products along the production line and past images of a similar product along the production line.

12. The system of claim 10, wherein each image of the plurality of images is classified into one of two clusters and the hypothesis testing uses a null hypothesis to identify variations in the images of the two clusters.

13. The system of claim 12, wherein the monitoring system is further configured to reject the null hypothesis in response to an observed probability being greater than a threshold for a defined significance level.

14. The system of claim 10, wherein the one or more production factors comprises one or more of inputs, noise, process changes, or a combination thereof.

15. The system of claim 14, wherein the process changes comprise a change to at least one of a date and time of production, an operator, a tool, a production, or a combination thereof.

16. The system of claim 10, wherein the products comprise a vehicle high-voltage battery pack and the one or more features relate to cell tab welds for cells within the vehicle high-voltage battery pack.

17. The system of claim 10, wherein the monitoring system is further configured to preprocess the plurality of images, wherein the preprocessing comprises centering and cropping each image of the plurality of images on a region of interest and masking out other regions of each of the images corresponding to noise.

18. One or more non-transitory computer-readable media storing processor-executable instructions that, when executed by at least one processor, cause the at least one processor to:
extract one or more features from a plurality of images;
classify the plurality of images based on the extracted one or more features to form one or more clusters of images, the classifying performed at least in part based on machine learning;
perform hypothesis testing on the one or more clusters of images based on one or more production factors;
identify variations in the one or more features resulting from the hypothesis testing; and
determine one or more production metrics based on the identified variations.

19. The one or more non-transitory computer-readable media of claim 18, wherein each image of the plurality of images is classified into one of two clusters and the hypothesis testing uses a null hypothesis to identify variations in the image of the two clusters, and wherein the at least one processor is further caused to:
reject the null hypothesis in response to an observed probability being greater than a threshold for a defined significance level.

20. The one or more non-transitory computer-readable media of claim 18, wherein the products comprise a vehicle high-voltage battery pack and the one or more features relate to cell tab welds for cells within the vehicle high-voltage battery pack, and wherein the at least one processor is further caused to:
preprocess the plurality of images, wherein the preprocessing comprises centering and cropping each image of the plurality of images on a region of interest and masking out other regions of each of the images corresponding to noise.
